(19) United States
(12) Patent Application Publication
(10) Pub. No.: US 2015/0259470 A1
(43) Pub. Date: Sep. 17, 2015

(54) LOW-MOLAR-MASS POLYMERS COMPRISING AT LEAST ONE 4-METHYLETHER-1,3-DIOXOLAN-2-ONE END GROUP

(71) Applicant: BOSTIK SA, La Plaine St Denis (FR)

(72) Inventors: Guillaume Michaud, Compiegne (FR); Frederic Simon, Pont L'Eveque (FR); Stephane Fouquay, Mont Saint-Aignan (FR); Liana Annuziata, Salerno (IT); Sophie Guillaume, Vitre (FR); Jean-Francois Carpentier, Acigne (FR)

(73) Assignee: BOSTIK SA, La Plaine St Denis (FR)

(21) Appl. No.: 14/440,804

(22) PCT Filed: Oct. 30, 2013
(86) PCT No.: PCT/FR2013/052595

§ 371 Date: May 5, 2015

(30) Foreign Application Priority Data
Nov. 5, 2012 (FR) 1260486

(51) Int. Cl. C08G 63/91; C08G 71/04; C08F 8/00

(52) U.S. Cl. CPC C08G 63/91; C08F 8/00; C08G 71/04

(57) ABSTRACT

A polymer of formula (I):

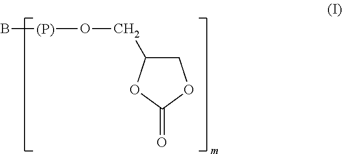

in which P is a divalent polymeric radical other than a polyoxypropylene radical; m is a number from 1 to 6; B is a monovalent, divalent, trivalent, tetravalent, pentavalent or hexavalent radical, having from 1 to 44 carbon atoms per molecule; the divalent polymeric radical P being such that the number-average molar mass Mn of the polymer of formula (I) is in a range from 400 to 8000 g/mol and such that the polydispersity (Pd) of the polymer of formula (I) is within a range from 1.0 to 4.0.

Process for preparing the polymer of formula (I).

Process for preparing polyurethanes, by reaction of a polymer of formula (I) with a compound, having an amine group, and also polyurethanes that may be thus obtained.

The present invention relates to low-molar-mass polymers comprising at each of their ends a 1,3-dioxolan-2-one (or cyclocarbonate) end group linked to a polymer chain via a methyl ether function (CH2-O) substituted alpha (a) to the 1,3-dioxolan-2-one, and to the use thereof for preparing polyurethanes by reaction with a compound comprising at least one amine group. These polyurethanes, once formulated, are intended to be used in coating, mastics or adhesives, as additives and/or as resins.

Polyurethanes are conventionally synthesized by reaction between a diol and a diisocyanate. Diisocyanates are compounds that are toxic per se, and are generally obtained from phosgene, which is itself very toxic by inhalation or by contact. The manufacturing process used industrially generally involves the reaction of an amine with an excess of phosgene to form an isocyanate.

The search for alternatives to the synthesis of polyurethanes without using isocyanate (Non-Isocyanate Polyurethane, or NIPU), is thus a major challenge.

This search has been the subject of numerous research and development studies. The approaches that have been the most intensively studied concern the use of polymers in which each of the end groups comprises at the end a 1,3-dioxolan-2-one group. These polymers react with amines or amine oligomers to form polyurethanes.

However, none of the proposed solutions is satisfactory.

Patent application WO 03/028 644, from Eurotech Ltd, describes virtually pure 1,3-dioxolan-2-one 4-methyl ether oligomers. It in particular describes polypropylene glycol 1,3-dioxolan-2-one 4-methyl ether oligomers of low molar mass, typically from 600 to 1600 g/mol. These oligomers have a star-shaped structure comprising from 3 to 6 arms, each arm comprising a polypropylene glycol 1,3-dioxolan-2-one 4-methyl ether, and all the arms being connected together via a hydrocarbon-based group. The 1,3-dioxolan-2-one 4-methyl ether group is at the end of the end group of each arm, the hydrocarbon-based group being at the other end of the arm. No example of synthesis of a polypropylene glycol 1,3-dioxolane 4-methyl ether is described.

Patent application US 2007/0 151 666, from Henkel Corp., describes a bonding agent system which comprises at least two components A and B. Component A is a polymer comprising at least two groups, preferably end groups, each comprising a 1,3-dioxolan-2-one group, preferably a 1,3-dioxolan-2-one end group. Component B is a compound comprising at least two primary and/or secondary amine groups. Such a bonding agent system is used as adhesive comprising two components (or two-pack), i.e. the two components are mixed together at the time of bonding. Said document mainly describes polymer components A comprising at each of their ends a 1,3-dioxolan-2-one group linked to a polymer chain via an ester or urethane function substituted cc to the 1,3-dioxolan-2-one. Consequently, component A comprises at least two end groups comprising CO or urethane functionalities. These functionalities are liable to pose problems during the synthesis of the adhesive system, since they may interact with other components in an undesired manner. In addition, they are responsible for an undesired increase in viscosity during the preparation of the two-pack adhesive.

The aim of the present invention is to provide novel intermediates for synthesizing polyurethanes without using isocyanate.

Thus, the present invention relates to a polymer of formula (I) comprising at least one 1,3-dioxolan-2-one 4-methyl ether end group:

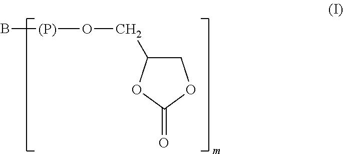

in which:
P is a polymeric divalent radical, with the proviso that P is other than a polyoxypropylene radical;
m is a number from 1 to 6, m is preferably chosen from 2 and 3, and even more preferably m is equal to 2;
B is a monovalent, divalent, trivalent, tetravalent, pentavalent or hexavalent radical, said radical generally comprising from 1 to 44 carbon atoms per molecule;
   the polymeric divalent radical P being such that the number-average molar mass Mn of the polymer of formula (I) is within a range from 400 to 8000 g/mol, preferably from 1000 to 4000 g/mol, and such that the polydispersity (Pd) of the polymer of formula (I) is within a range from 1.0 to 4.0.

The polydispersity (Pd) is defined as the ratio Mw/Mn, i.e. the ratio of the weight-average molar mass to the number-average molar mass of the polymer.

The two molar masses Mn and Mw are measured according to the invention by size exclusion chromatography (SEC), usually with PEG (polyethylene glycol) or PS (polystyrene) calibration.

According to the invention, the term “polyoxypropylene radical” means a radical formed exclusively from oxypropylene units.

The term “end group” means a group located at the end (or extremity) of the polymer chain.

The radical B may be linear or branched, may comprise at least one saturated and/or unsaturated bond, and may comprise at least one cyclic and/or alicyclic group.

The radical B is preferably chosen from the group formed by radicals derived from butadiene and radicals formed from methanol, ethylene glycol, propylene glycol, neopentyl glycol, fatty alcohol dimer, trimethylolpropane, pentaerythritol, glycerol, arabinol and sorbitol compounds, by departure of at least one hydroxyl group. The radical B is even more preferably chosen from the group formed by radicals formed from methanol, ethylene glycol, propylene glycol, neopentyl glycol, fatty alcohol dimer, trimethylolpropane, pentaerythritol, glycerol, arabinol and sorbitol compounds, by departure of at least one hydroxyl group. Three radicals derived from butadiene are illustrated in Example 3 below.

According to the invention, the polymeric divalent radical P may comprise at least one linear or branched chain, may comprise at least one saturated and/or unsaturated bond, and may comprise at least one cyclic and/or alicyclic group.

In general, the polymeric divalent radical P is chosen from the following divalent polymeric radicals:
divalent polyether radicals, said polyethers preferably comprising two hydroxyl ends, with the proviso that P is other than a polyoxypropylene radical;
divalent polycarbonate radicals, said polycarbonates preferably comprising two hydroxyl ends;
divalent polyester radicals, said polyesters preferably comprising two hydroxyl ends;
divalent polyether-polyester radicals, said polyether-polyester radicals preferably comprising two hydroxyl ends;
divalent poly(meth)acrylate radicals, said poly(meth)acrylates preferably comprising two hydroxyl ends;
divalent polyurethane radicals, said polyurethanes preferably comprising two hydroxyl ends;
divalent polyol radicals of natural origin, said polyols of natural origin preferably comprising two hydroxyl ends; and
divalent polyolefin radicals, said polyolefins preferably comprising two hydroxyl ends, and mixtures thereof.

Preferably, the polymeric divalent radical P is chosen from the following divalent polymeric radicals:
divalent polyether radicals, said polyethers preferably comprising two hydroxyl ends, with the proviso that P is other than a polyoxypropylene radical;
divalent polyester radicals, said polyesters preferably comprising two hydroxyl ends;
divalent polyether-polyester radicals, said polyether-polyesters preferably comprising two hydroxyl ends;
divalent poly(meth)acrylate radicals, said poly(meth)acrylates preferably comprising two hydroxyl ends;
divalent polyurethane radicals, said polyurethanes preferably comprising two hydroxyl ends;
divalent polyol radicals of natural origin, said polyols of natural origin preferably comprising two hydroxyl ends; and
divalent polyolefin radicals, said polyolefins preferably comprising two hydroxyl ends, and mixtures thereof.

According to the invention, the term “mixture of polymeric divalent radicals” means a polymeric divalent radical derived from a copolymer, generally a block or statistical copolymer, of at least two polymers chosen from the group formed by polyethers, polycarbonates, polyesters, polyether-polyesters, poly(meth)acrylates, polyurethanes, polyols of natural origin and polyolefins, it being understood that in this case the polyethers may comprise polypropylene glycols. Said mixture preferably comprises two hydroxyl ends.

The divalent polyether radicals are preferably formed from polyethers comprising two hydroxyl ends. The polyethers are preferably chosen from aliphatic polyethers and aromatic polyethers. The divalent polyether radical generally comprises a plurality of oxyalkylene repeating units, preferably oxyethylene, oxypropylene, oxybutylene and/or oxyhexylene, it being understood that the polyether polyols are not polypropylene glycols.

As examples of aliphatic polyethers, mention may be made of oxyalkyl derivatives of diols (such as ethylene glycol, neopentyl glycol), and polytetramethylene glycols. These products are commercially available.

According to a preferred embodiment of the invention, the polymeric divalent radical is chosen from the group formed by polyoxyethylenes, polyoxybutylenes, polyoxyhexylenes, and block or statistical copolymeric mixtures thereof, and also block or statistical copolymeric mixtures of polyoxyethylenes, polyoxybutylenes, polyoxyhexylenes and polyoxypropylenes.

Preferably, the polyether is chosen from the group formed by generally statistical or block copolymers formed from ethylene oxide and propylene oxide, it being understood that the polyether is not a polypropylene glycol.

The divalent polyether radicals are preferably, according to the invention, polyethylene glycols, polytetramethylene glycols and polyethylene/polypropylene glycols (copolymers generally having a block or statistical structure).

As is known to those skilled in the art, the polyethers may be prepared by ring-opening polymerization of a cyclic compound comprising oxygen such as a compound chosen from the group formed by ethylene oxide, propylene oxide, butylene oxide, often in the presence of an initiator such as a monomeric diol, it being understood that the polyether is not a polypropylene glycol.

More preferably, the polyether is a polytetramethylene glycol preferably chosen from commercial products such as PolyTHF®.

The divalent polycarbonate radicals are preferably formed from polycarbonates comprising two hydroxyl ends. The polycarbonates are generally those obtained by reacting at least one divalent alcohol, for instance ethylene glycol, diethylene glycol, propylene glycol, dipropylene glycol, neopentyl glycol, 1,4-butanediol, 1,5-pentanediol, 3-methyl-1,5-hexanediol, 1,6-hexanediol, 1,8-octanediol, 1,10-decanediol, 1,12-dodecanediol or 1,12-hydroxystearyl alcohol with at least one compound chosen from the group formed by dialkyl carbonates, diaryl carbonates and phosgene.

The divalent polyester radicals are preferably formed from polyesters comprising two hydroxyl ends. The polyesters are generally chosen from aliphatic and aromatic polyesters, of amorphous, semicrystalline or crystalline type, and mixtures of these compounds. Examples that may be mentioned include polyesters resulting from the condensation of:
at least one aliphatic diol (linear, branched or cyclic, saturated or unsaturated) or aromatic diol, such as ethanediol, 1,2-propanediol, 1,3-propanediol, 1,4-butanediol, 1,6-hexanediol, fatty alcohol dimers, glycerol, trimethylolpropane, 1,6-hexanediol, 1,2,6-hexanetriol, sucrose, glucose, sorbitol, pentaerythritol, mannitol, triethanolamine or N-methyldiethanolamine with:
at least one polycarboxylic acid or ester or anhydride derivative thereof such as 1,6-hexanedioic acid, dodecanedioic acid, azelaic acid, sebacic acid, adipic acid, 1,18-octadecanedioic acid, fatty acid dimers, phthalic acid, succinic acid, and mixtures of these acids, an unsaturated anhydride such as maleic or phthalic anhydride, or a lactone such as caprolactone.

Many of these products are commercially available.

Among these polyesters, mention may thus be made of the following commercial products, with hydroxyl functionality equal to 2:
Tone® 0240 (available from the company Union Carbide) which is a polycaprolactone with a molecular mass of about 2000 Da, of IOH equal to 56, having a melting point of about 50° C.;
Realkyd XTR 10410 (available from the company Cray Valley), with a molar mass of about 1000 g/mol, of IOH equal to 112 and which is a liquid product with a viscosity of 1000 mPa·s at 35° C.;
Dynacoll® 7381 with a molecular mass of about 3500 Da, of IOH equal to 30, and with a melting point of about 65° C.,
Dynacoll® 7360 with a molecular mass of about 3500 Da, of IOH equal to 30, and with a melting point of about 55° C.,
Dynacoll® 7330 with a molecular mass of about 3500 Da, of IOH equal to 30, having a melting point of about 85° C.,
Dynacoll® 7363 with a molecular mass of about 5500 Da, of 10H equal to 21 and with a melting point of about 57° C.

These Dynacoll® products are sold by the company Evonik.

The divalent polyether-polyester radicals are preferably formed from polyether-polyesters comprising two hydroxyl ends. The polyether-polyesters are polyesters as described above in which the polyesters have been totally or partly replaced with polyethers (including polypropylene glycols).

The divalent poly(meth)acrylate radicals are preferably formed from poly(meth)acrylates comprising two hydroxyl ends. The poly(meth)acrylates are generally obtained by polymerization of acrylic monomers of alkyl(meth)acrylate type in which the alkyl group is preferentially a group such as methyl, ethyl, propyl, butyl, or 2-ethylhexyl with hydroxyalkyl(meth)acrylate monomers in which the hydroxyalkyl group is preferably a group such as hydroxyethyl, hydroxypropyl, hydroxybutyl or 1-hydroxy-2-ethylhexyl.

The divalent polyurethane radicals are preferably formed from polyurethanes comprising two hydroxyl ends. The polyurethanes are generally obtained by reaction of polyethers, polyesters, polyether-polyesters, polyolefins and/or polyols of natural origin with at least one diisocyanate of formula:

NCO—R—NCO

in which R represents an aliphatic or aromatic divalent hydrocarbon-based radical comprising from 5 to 15 carbon atoms, and which may be linear, branched or cyclic. Examples that will be mentioned include isophorone diisocyanate (IPDI), toluene diisocyanate (TDI) isomers and methylenediphenyl diisocyanate (MDI) isomers.

The divalent polyol radicals of natural origin are preferably formed from polyols of natural origin comprising two hydroxyl ends. Polyols of natural origin, or NOPS (Natural Oil PolyolS), are generally polyols obtained by chemical alteration of natural fats and oils, which are generally unsaturated and predominantly of oleic type (rapeseed oil, sunflower oil, olive oil, castor oil, etc.). Mention may be made of NOPs obtained from fatty acid dimers, fatty hydroxy acids and methyl esters thereof, fatty alcohols, which are usually dimers or trimers, and, more generally, polyacids and polyalcohols of renewable origin. It is also possible to obtain synthetic fatty hydroxy acids by epoxidation of unsaturated oils and subsequent ring opening with alcohols or carboxylic acids, polyols by hydroformylation or hydrogenation of unsaturated oils, by degradation of natural fats and/or oils, such as alcoholysis or ozonolysis, and subsequent chemical crosslinking, for example by re-esterification or dimerization, of the degradation products thus obtained, or alternatively derivatives of these products. Among the synthetic fatty hydroxy acids that are preferred according to the invention, mention will be made of esters obtained by hydroformylation and hydrogenation of methyl esters of unsaturated fatty acids with a high content of oleic fraction.

Among the NOPs that are preferred according to the invention, mention will be made of estolide diols obtained by polymerization of fatty hydroxy acids, and polyester diols on a base of fatty acid dimers and of diols of renewable origin.

The divalent polyolefin radicals are preferably formed from polyolefins comprising two hydroxyl ends. The polyolefins are generally poly-hydroxyfunctional polyolefins, polyisobutylenes, polyisoprenes; polyhydroxy functional ethylene-propylene, ethylene-butylene and ethylene-propylene diene copolymers, as produced, for example, by the company Kraton Polymers; polyhydroxy-functional diene polymers, in particular of 1,3-butadiene, which may be produced in particular by anionic polymerization; polyhydroxy-functional copolymers which comprise dienes, such as 1,3-butadiene or mixtures of diene and of vinyl monomer(s) such as styrene, acrylonitrile, vinyl chloride, vinyl acetate, vinyl alcohol, isobutylene and isoprene, for example polyhydroxy-functional acrylonitrile butadienes; copolymers that may be produced, for example, from epoxides or amino alcohols and carboxy-terminal acrylonitrile butadiene copolymers (for instance as commercially available under the names Hypro® (previously Hycar®) CTBN, CTBNX and ETBN from the company Nanoresins AG, Germany or from the company Emerald Performance Materials LLC; and also polyhydroxy-functional hydrogenated polymers and diene copolymers. An example that will be mentioned is poly BD® R45 HTLO.

In the preferred case according to the invention in which m is equal to 2, the assembly —P—B—P—, which consists of two divalent polymeric radicals P linked via the divalent compound B, generally has, according to the invention, a mean molar mass from about 67 to 8000 g/mol, and preferably from about 167 to 4000 g/mol. In such a case, the formula of compound B may be deduced from the formula of the corresponding divalent radical polymer —P—B—P—. For example, if the assembly —P—B—P— consists of at least one divalent monomer unit M repeating numerous times, and if M is a divalent radical containing from 1 to 44 carbon atoms, B is one of the mid-chain monomer units. This will be the case in Examples 2 and 3 according to the invention described below.

In a particularly preferred embodiment according to the invention, the polymeric divalent radical P is chosen from the following polymeric radicals:
divalent polyether radicals, said polyethers preferably comprising two hydroxyl ends, with the proviso that P is other than a polyoxypropylene radical;
divalent polyester radicals, said polyesters preferably comprising two hydroxyl ends;
divalent polyether-polyester radicals, said polyether-polyesters preferably comprising two hydroxyl ends; and
divalent polyurethane radicals, said polyurethanes preferably comprising two hydroxyl ends, and mixtures thereof.

The polymeric divalent radical is preferably chosen from the group formed by polyoxypropylene-polyoxyethylenes, for instance commercial products such as PolyTHF®.

The invention also relates to a process for preparing at least one polymer of formula (I) according to the invention comprising the reaction of at least one polymer of formula (II) below in which B, P and m have the same meaning as that of formula (I):

B—[—(P)—OH]m (II)

with at least one compound derived from glyceryl carbonate, preferably chosen from 4-chloromethyl-1,3-dioxolan-2-one, methyl-1,3-dioxolan-2-one 4-tosylate and methyl-1,3-dioxolan-2-one 4-mesylate.

Glyceryl carbonate is the compound of CAS number 931-40-8 or 4-hydroxymethyl-2-oxo-1,3-dioxolan-2-one, i.e. a cyclocarbonate comprising a hydroxymethyl (—CH2-OH) substitution in position 4.

The term “glyceryl carbonate derivative” means a compound comprising a cyclocarbonate radical comprising a methylene (—CH2-) substitution in position 4. Among these compounds, mention may preferably be made of 4-chloromethyl-1,3-dioxolan-2-one (CAS number 2463-45-8), methyl-1,3-dioxolan-2-one 4-tosylate and methyl-1,3-dioxolan-2-one 4-mesylate.

Finally, the invention relates to a process for preparing polyurethanes, comprising the reaction of at least one polymer of formula (I) according to the invention with at least one compound comprising at least one, preferably at least two, amine groups, chosen, for example, from amines, diamines, triamines and polyamines, and also polyurethanes that may be obtained via this preparation process.

The amines are preferably such that at least one amine group, preferably all the amine groups, are primary amine groups.

The polyurethanes thus obtained, which are novel, are advantageously free of isocyanate.

These polyurethanes, once formulated (i.e. placed in formulation with other optional additives), are intended to be used in coatings, mastics or adhesives, as fillers and/or as resins. It is also possible independently to formulate the polymer of formula (I) and the compound comprising at least one amine group, before mixing them.

The invention will be better understood in the light of the examples that follow.

### EXAMPLES

The examples that follow illustrate the invention without, however, limiting its scope.

### Experimental Protocol

All the experiments were performed, if necessary, under an argon atmosphere.

The glyceryl carbonate was a product from the company ABCR Chemical. All the other reagents were produced by the company Aldrich. The 4-chloromethyl-1,3-dioxolan-2-one was synthesized according to the literature [Dibenedetto A.; Angelini, A.; Aresta, M.; Ethiraj, J.; Fragale, C.; Nocito, F. Tetrahedron 2011, 67, 1308-1313].

The tetrahydrofuran (THF) was subjected to reflux over Na/benzophenone, distilled and degassed before use. All the other solvents were used as received.

The FTIR (Fourier transform infrared) spectra were recorded on a Shimadzu IRAffinity-1 machine.

The NMR spectra were recorded on a Brüker AM-500 spectrometer at 298 K in CDCl3. The chemical shifts were referenced relative to tetramethylsilane (TMS) using the (1H) or (13C) resonance of the deuterated solvents. The number-average and weight-average molar masses (Mn and Mw) and the polydispersity Pd (Mw/Mn) of the polymers were determined by gel permeation chromatography (GPC) using a Polymer Laboratories PL-GPC 50 machine. Mass spectra were recorded with a high-resolution AutoFlex LT spectrometer (Brüker) equipped with an N2 pulsed laser source (337 nm, 4 ns of pulse width).

### 1. Synthesis of methyl-1,3-dioxoalan-2-one 4-tosylate

Methyl-1,3-dioxolan-2-one 4-tosylate was synthesized in the present example so as to be used in Examples 2 and 3 according to the invention.

This synthesis was performed according to scheme 1 below:

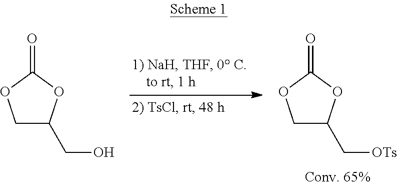

In which Ts is the tosyl or 4-toluenesulfonyl radical CH3C6H4SO2- and in which “rt” means room temperature.

This is a synthesis as described, for example, in the 2006 communication from the University of Orleans (authors: Pukleviciene, Simao et al.) (http://www.univ-orleans.fr/icoa/communications/com2006/simao.pdf) or in patent U.S. Pat. No. 5,326,885 (Example 4).

NaH (1.5 g, 65 mmol) was added to a solution of glyceryl carbonate (7 g, 59 mmol) in dry THF (80 ml) at 0° C. The resulting suspension was maintained at 0° C. for 20 minutes, and was then warmed to room temperature and stirred for a further 40 minutes. Next, 4-toluenesulfonyl chloride (CH3C6H4SO2Cl, tosyl chloride) (11.3 g, 59 mmol) was added. The resulting white suspension was mixed at room temperature for 48 hours. Next, a few drops of saturated aqueous NH4Cl solution were added. The product was extracted with toluene (3 minutes; 50 ml), the organic fraction was dried over Na2SO4 and the solvent was distilled off by rotary evaporation. A white powder of the desired product was obtained (yield=10.5 g), as confirmed by 1H and 13C NMR.

The NMR measurements gave: 1H NMR (DMSO d6, ppm): 7.79 (d, 2H), 7.44 (d, 2H), 4.90 (m, 1H), 4.48 (t, 1H), 4.2 (m, 3H), 2.44 (s, 3H). 13C NMR (DMSO d6, ppm): 154.8, 145.8, 132.2, 130.7, 128.2, 74.2, 69.9, 65.9, 21.6.

### 2. Synthesis of a Polymer in Accordance with the Invention, Comprising Two 1,3-dioxolan-2-one 4-methyl ether End Groups and a Divalent Polyester Polymeric Radical

This synthesis was performed according to scheme 2 below:

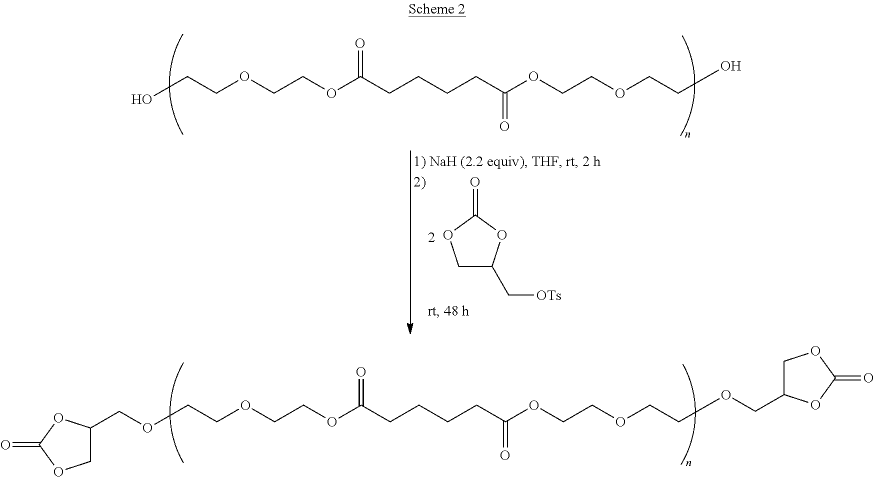

A polyester compound comprising two hydroxyl end groups Realkyd XTR 10410 (1000 g/mol) (Cray Valley) was degassed, stored over molecular sieves and used without further purification. It was characterized by NMR, MALDI-TOF and FTIR spectrometry. It corresponds to formula (II) in which m is equal to 2 and —P—B—P— is the polymer unit repeating n times. B is a mid-chain monomer unit.

This compound was functionalized with methyl-1,3-dioxolan-2-one 4-tosylate of Example 1.

Thus, NaH (0.120 g, 5.1 mmol) was added to a solution of dihydroxy-polyester (2.3 g, 2.3 mmol) in dry THF (30 ml) at room temperature. The resulting suspension was stirred for 2 hours. Next, methyl-1,3-dioxolan-2-one 4-tosylate (1.27 g; 4.65 mmol), derived from Example 1, was added and the resulting white suspension was mixed at room temperature for 48 hours. Next, a few drops of saturated aqueous NH4Cl solution were added. The product was extracted with toluene (3 minutes; 50 ml), the organic fraction was dried over Na2SO4 and the solvent was distilled off by rotary evaporation. A clear-colored oil was obtained (yield=93%). The resulting product was characterized by 1D and 2D NMR spectroscopy, IR spectroscopy and MALDI TOF spectroscopy, demonstrating that it was completely functionalized (96%).

The NMR analyses gave: 1H NMR (CDCl3) ppm: 4.35-4.0 (m, CH2O 1,3-dioxolan-2-one), 4.2 (bm, CH2-OCO polymer), 3.75 (CH2O end of chain), 3.7-3.6 (m, CH2-O polymer), 3.52 (bm, CH2O end of chain), 3.2 (m, CHO 1,3-dioxolan-2-one), 2.8-2.6 (m, CH2O 1,3-dioxolan-2-one), 2.3 (m, CH2C polymer), 1.6 (m, CHCO polymer). 13C NMR (CDCl3) ppm: 173.1 (CO2 polymer), 155.0 (1,3-dioxolan-2-one), 72.2, 68.9, 66.9 (1,3-dioxolan-2-one), 63.2, 63.1, 61.5, 48.9 (1,3-dioxolan-2-one), 44.5 (1,3-dioxolan-2-one), 33.5, 24.1.

Analysis by infrared spectroscopy (FTIR) showed the disappearance of the band for the hydroxyl end group of the polyester at 3500 cm-1 and the appearance of a band for the carbonate group at 1743 cm-1.

Next, a polymer in accordance with the invention was indeed obtained, comprising two 1,3-dioxolan-2-one 4-methyl ether end groups and a divalent polyester polymeric radical. This polymer corresponds to formula (I) in which m is equal to 2 and —P—B—P— is the polymer unit repeating n times. B is a mid-chain monomer unit.

### 3. Synthesis of a Polymer in Accordance with the Invention, Comprising Two 1,3-dioxolan-2-one 4-methyl ether End Groups and a Divalent Polybutadiene Polymeric Radical

This synthesis was performed according to scheme 3 below:

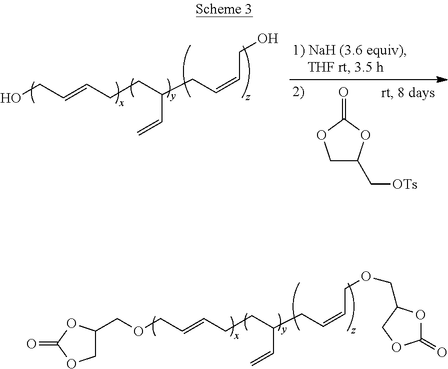

A hydroxyl-terminated polybutadiene compound PolyBD R45 HTLO (Cray Valley) was degassed, stored over molecular sieves and used without further purification. The structure and molar mass of the polybutadiene are explained in Table 1 below. It corresponds to formula (II) in which m is equal to 2 and —P—B—P— is a divalent triblock polymeric radical of polymer units of divalent butadiene radicals, each being respectively repeated x, y or z times. The monomer unit repeated x times is the divalent butadiene radical of E form (for Entgegen=trans). The monomer unit repeated y times is the divalent isobutadiene radical. The monomer unit repeated z times is the divalent butadiene radical of Z form (for Zusammen=cis). B is a mid-chain butadiene monomer unit.

TABLE 1

| | Mn | Mw | | % 1,4-cis | % 1,4-trans | % 1,2 |
|---|---|---|---|---|---|---|
| | (g/mol) | (g/mol) | Pd | units | units | units |
| POLYBD | 3 452 | 8 289 | 2.4 | 20.0 | 60.0 | 20.0 |
| R45 HTLO | | | | | | |

This compound was functionalized with methyl-1,3-dioxolan-2-one 4-tosylate of Example 1.

Thus, NaH (80 mg, 3.3 mmol) was added slowly to a solution of PolyBD R45 HTLO (2.9 g, 0.85 mmol) in dry THF (40 ml) at room temperature. The resulting suspension was stirred for 3 hours, to ensure complete deprotonation. Next, methyl-1,3-dioxolan-2-one 4-tosylate (0.500 g, 1.8 mmol) was added and the resulting white suspension was mixed at room temperature for 6 days. Next, a few drops of saturated NH4Cl solution were added. The product was extracted with toluene (3 minutes; 50 ml), the organic fraction was dried over Na2SO4 and the solvent was then distilled off by rotary evaporation. A very viscous pale yellow oil was obtained (yield: 80%). The resulting product was characterized by NMR spectroscopy, and FTIR spectroscopy, demonstrating that it was completely functionalized (98%).

Given the complexity of the NMR spectra obtained, only the significant shifts have been reproduced here: 1H NMR (CDCl3) ppm: 4.6 (m, 1,3-dioxolan-2-one), 4.4 (m, 1,3-dioxolan-2-one), 4.2 (m, CH2O end of chain), 4.1 (m, CH2OH end of chain plus 1,3-dioxolan-2-one, 3.6 (m, CH2O end of chain), 3.45-3.3 (m, CH2OH end of chain plus 1,3-dioxolan-2-one), 2.9-2.7 (m, 1,3-dioxolan-2-one). 13C NMR (CDCl3) ppm: only the 1,3-dioxolan-2-one shifts: 154.0, 68.0, 48.5, 44.5.

Analysis by infrared spectroscopy (FTIR) showed of the band for the end hydroxyl group of the polyester at 3500 cm-1 and the appearance of a band for the carbonate group at 1743 cm-1.

Next, a polymer in accordance with the invention was indeed obtained, comprising two 1,3-dioxolan-2-one 4-methyl ether end groups and a divalent polybutadiene polymeric radical. It corresponds to formula (I) in which m is equal to 2 and —P—B—P— is a divalent triblock polymeric radical of polymer units of divalent butadiene radicals, each being respectively repeated x, y or z times. The monomer unit repeated x times is the divalent butadiene radical of E form. The monomer unit repeated y times is the divalent isobutadiene radical. The monomer unit repeated z times is the divalent butadiene radical of Z form. B is a mid-chain butadiene monomer unit.

### 4. Synthesis of Polyurethanes Starting with the Two Polymers in Accordance with the Invention and Comprising Two 1,3-dioxolan-2-one 4-methyl ether End Groups of Examples 2 and 3

Each of the two polymers in accordance with the invention each comprising two 1,3-dioxolan-2-one 4-methyl ether end groups of Examples 2 and 3 was reacted at 80° C., in a stoichiometric ratio, with a primary diamine such as a polyether diamine (Jeffamine EDR 176, Huntsman), until complete disappearance of the characteristic infrared band for the 1,3-dioxolan-2-one groups and appearance of the characteristic bands for a carbamate group (band at 1700 cm-1). The reaction lasted 72 hours in each case.

The products thus synthesized led to the formation of two polymers of polyhydroxyurethane type, which appropriately formulated two-pack mixtures made it possible to obtain the desired adhesive properties.

1. A polymer of formula (I) comprising at least one 1,3-dioxolan-2-one 4-methyl ether end group: 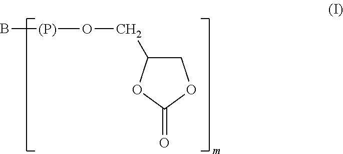
in which:
P is a polymeric divalent radical, with the proviso that P is other than a polyoxypropylene radical;
m is a number from 1 to 6, m is preferably chosen from 2 and 3, and even more preferably m is equal to 2;
B is a monovalent, divalent, trivalent, tetravalent, pentavalent or hexavalent radical, said radical generally comprising from 1 to 44 carbon atoms per molecule;
the polymeric divalent radical P being such that the number-average molar mass Mn of the polymer of formula (I) is within a range from 400 to 8000 g/mol, preferably from 1000 to 4000 g/mol, and such that the polydispersity (Pd) of the polymer of formula (I) is within a range from 1.0 to 4.0.

2. The polymer as claimed in claim 1, said compound being such that B is chosen from the group formed by radicals derived from butadiene and radicals formed from methanol, ethylene glycol, propylene glycol, neopentyl glycol, fatty alcohol dimer, trimethylolpropane, pentaerythritol, glycerol, arabinol and sorbitol compounds.

3. The polymer as claimed in claim 1, such that the divalent polymeric radical P is chosen from the following polymeric radicals:
polyether radicals, said polyethers preferably comprising two hydroxyl ends;
polycarbonate radicals, said polycarbonates preferably comprising two hydroxyl ends;
polyester radicals, said polyesters preferably comprising two hydroxyl ends;
polyether-polyester radicals, said polyether-polyester radicals preferably comprising two hydroxyl ends;
poly(meth)acrylate radicals, said poly(meth)acrylates preferably comprising two hydroxyl ends;
polyurethane radicals, said polyurethanes preferably comprising two hydroxyl ends;
polyol radicals of natural origin, said polyols of natural origin preferably comprising two hydroxyl ends; and
polyolefin radicals, said polyolefins preferably comprising two hydroxyl ends, and mixtures thereof.

4. The polymer as claimed in claim 1, such that the divalent radical P is chosen from the following polymeric radicals:
polyether radicals, said polyethers preferably comprising two hydroxyl ends, with the proviso that P is other than a polyoxypropylene radical;
polyester radicals, said polyesters preferably comprising two hydroxyl ends;
polyether-polyester radicals, said polyether-polyesters preferably comprising two hydroxyl ends;
polyurethane radicals, said polyurethanes preferably comprising two hydroxyl ends, and mixtures thereof.

5. A process for preparing at least one polymer of formula (I) as claimed in claim 1, comprising the reaction of at least one polymer of formula (II) below, in which B, P and m have the same meaning as that of formula (I):
B—[—(P)—OH]m (II)
with at least one compound derived from glyceryl carbonate, preferably chosen from 4-chloromethyl-1,3-dioxolan-2-one, methyl-1,3-dioxolan-2-one 4-tosylate and methyl-1,3-dioxolan-2-one 4-mesylate.

6. A process for preparing polyurethanes, comprising the reaction of at least one polymer of formula (I) as claimed in claim 1 with at least one compound comprising at least one, preferably at least two, amine groups, chosen, for example, from amines, diamines, triamines and polyamines.

7. A polyurethane that may be obtained via the preparation process as claimed in claim 6.
